(19) United States
(12) Patent Application Publication
(10) Pub. No.: US 2015/0300505 A1
(43) Pub. Date: Oct. 22, 2015

(54) SEAL ARRANGEMENT FOR A CONTROL VALVE

(71) Applicant: Schaeffler Technologies GMBH & CO. KG, Herzogenaurach (DE)

(72) Inventors: Michael Weiss, Herzogenaurach (DE); Uli Grosskopf, Adelsdorf (DE); Klaus Hahn, Furth-Burgfarrnbach (DE)

(73) Assignee: Schaeffler Technologies GMBH & CO. KG, Herzogenaurach (DE)

(21) Appl. No.: 14/435,329

(22) PCT Filed: Jul. 17, 2013
(86) PCT No.: PCT/DE2013/200055

§ 371 Date: Apr. 13, 2015

(30) Foreign Application Priority Data
Oct. 16, 2012 (DE) 10 2012 218 801.0

(51) Int. Cl. F16K 1/42

(52) U.S. Cl. CPC F16K 1/42

(57) ABSTRACT

A seal arrangement for a control valve (1), which seal arrangement is designed for sealing a supply connection (3) for a valve housing (4), this connection being formed as a bore (2), and the seal arrangement can be brought into contact with a valve body (5) mounted in the valve housing (4). The seal arrangement has a first and a second sealing element (6, 7) and a connecting piece (8), with the connecting piece (8) having a main body (9) protruding into the valve housing (4) and a carrier body (10) running radially around the main body (9). The carrier body (10) is supported on an end face (11) of the valve housing (4) and both the first and the second sealing elements (6, 7) directly contact the connecting piece (8) in a sealing manner.

### FIELD OF THE INVENTION

The present invention relates to a seal arrangement for a control valve, which seal arrangement is realized for sealing a feed connection of a valve housing, wherein the seal arrangement can be moved to abut against a valve body which is mounted in the valve housing,

### BACKGROUND

A seal arrangement of a control valve according to the aforementioned genus is known from document DE 102009025341 A1. In particular where the valve mechanics are driven in electromotive manner, in the case of a coolant controller which comprises valve mechanics traversed by coolant, a reliably permanently sealed separation of component regions traversed by coolant and electric/mechanical component regions must be ensured. Otherwise, coolant could penetrate via a seal leak into the region of the electromotive driving means and there cause an electric short circuit and/or progressive wear which can then result in the failure of the drive for the coolant controller. However, reliable sealing of the coolant flow paths in as permanent a manner as possible must also be provided in the case of control valves which are not operated in an electromotive manner. For here as well, seal leaks can result in the operating reliability of the system being compromised. The seal arrangement of the aforementioned document is situated in a control valve, the valve housing of which as well as the valve body being produced as usual from plastics material. Due to the good finish quality of the plastics material, a very good sealing function can be achieved. However, in the case of more cost-efficient realizations of the valve housing, for example from cast metal, the surfaces of which are not post-treated, a sealing function on a rough surface is not ensured.

### SUMMARY

The object underlying the invention is to provide a seal arrangement which enables a reliable sealing function even in the case of valve housing with rough surface finishes.

The object is achieved according to the invention in that the seal arrangement comprises a first and a second sealing element, as well as a connecting piece. The connecting piece comprises a basic body which protrudes into the valve housing and a carrier body which runs radially around the basic body. The carrier body rests on an end face of the valve housing. Both the first and the second sealing element abut against the connecting piece in a sealing manner. Several control valves are often arranged in one complex component; normally in order to process the surface finish of the individual valve housings such that they are sufficient for an optimum sealing face, expensive, repeated re-clamping is necessary due to the many different axes. A seal arrangement which saves on said additional processing steps or minimizes the cost thereof is provided in order to avoid this.

The advantage in this case is that the surfaces of the connecting piece against which the sealing elements abut, where applicable, are able to be pre-treated before they are mounted into the valve housings of the control valves. It is particularly advantageous when the connecting piece can be produced in a finish-formed or off-mold manner. Finish-formed and off-mold means that the injection molded part comes out of the mold in the finished state and in particular does not have to be machine-finished. The production costs of the processing machine, in particular compared to components which are machined, can clearly be reduced as a result. In the case of a connecting piece which is produced in the afore-described manner, no further finishing steps occur.

When defining the invention, it is provided that the first sealing element is realized as a ring and the second sealing element is realized as a sealing sleeve, having a sealing lip which runs radially around its outside surface. The sealing ring can be arranged both on the end face and on the upper edge of the inside face of the valve housing.

It is provided according to the invention that the first sealing element is arranged between the bore of the valve housing and the outside circumferential face of the connecting piece, wherein the second sealing element is arranged between the inside circumferential face of the connecting piece and the valve body. A further possibility of the invention is provided in that the first sealing element is arranged between the end face of the valve housing and the face of the carrier body which faces the end face of the valve housing, wherein the second sealing element is arranged between the inside circumferential face of the connecting piece and the valve body.

In a preferred development of the invention, it is provided that the finish quality of the valve housing is only improved by means of a finishing process on the seal contact faces, the remaining surface of the valve housing remains untreated. The seal contact faces are situated according to the invention only at easily accessible part regions of the valve housing; thus, for example, on the end face of the valve housing, for the case where the first sealing element, which is realized as an O-ring seal, is to achieve an axial sealing effect or on the upper end of the inside face of the bore of the valve housing such that a radial sealing effect is able to be achieved.

It is provided as an option to arrange a seal arrangement of the afore-mentioned type inside a thermal management module, wherein the seal arrangement is arranged inside the control valves of the thermal management module and is provided for sealing coolant leaks.

### BRIEF DESCRIPTION OF THE DRAWINGS

Exemplary embodiments of the invention are shown in FIGS. 1 and 2 which are described in detail below, the invention not being restricted to said exemplary embodiments.

In the drawings which follow:

FIG. 1 shows a control valve with a seal arrangement, and

FIG. 2 shows a control valve with an alternative seal arrangement.

### DETAILED DESCRIPTION OF THE PREFERRED EMBODIMENTS

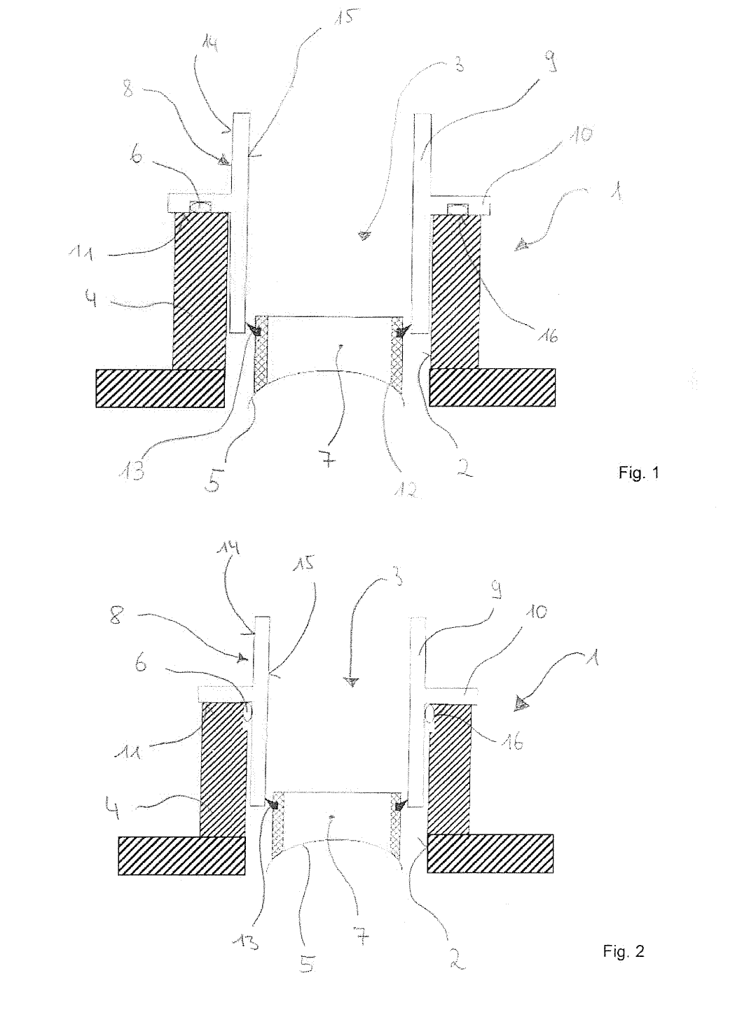

FIG. 1 shows a control valve 1 which comprises a valve housing 4 and a valve body 5. A seal arrangement according to the invention is realized in such a manner that it seals the feed connection 3 of the valve housing 4, which is realized as a bore 2, against unwanted coolant leaks. The seal arrangement comprises a first and a second sealing element 6, 7 as well as a connecting piece 8. The connecting piece 8 comprises a basic body 9 which protrudes into the valve housing 4 and a carrier body 10 which runs radially around the basic body 9. The carrier body 10 rests on an end face 11 of the valve housing 4. The two sealing elements 6, 7, in turn, abut against the connecting piece 8 in a sealing manner. The first sealing element 6 is realized as an O-ring seal. The second sealing element 7 is realized as a sealing sleeve 12 with a sealing lip 13 which runs radially around its outside face. The O-ring seal 6 (first sealing element) is arranged between the end face 11 of the valve housing 4 and the face of the carrier body 10 which faces the end face 11 of the valve housing 4. The sealing lip 13 of the second sealing element 7 seals the control valve 1 radially by abutting against the inside circumferential surface 15 of the connecting piece 8. At the same time, the sealing sleeve 12 abuts against the valve body 5. In said exemplary embodiment, the surface of the bore 2 of the valve housing 4 has not been treated with an additional smoothing turning process. In said example, simply the surface of the end face 11 of the valve housing has to be smoothed by means of a planer in such a manner that the O-ring seal 6 (first sealing element) is able to abut against a fluid-tight contact surface 16.

FIG. 2 differs from FIG. 1 simply in the arrangement of the first sealing element 6. In said exemplary embodiment, the O-ring seal 6 (first sealing element) is arranged between the bore 2 of the valve housing 4 and the outside circumferential surface 14 of the connecting piece 8. With this arrangement, as well as the sealing of the sealing lip 13 of the second sealing element 7 which acts in the axial direction, another radially acting sealing can be achieved as a result of the O-ring seal 6. However, with this arrangement it is necessary, by means of a turning tool, for a small sealing contact face 16 to be provided on the inside surface of the bore 2 in order to be able to achieve an optimum sealing effect.

Both embodiments of the seal arrangement make it possible to ensure reliable sealing of the coolant flow paths against leakage even when the valve housing 4 is produced in a favorable manner (e.g. by means of cast metal) and comprises rough surfaces. The finishing of the surfaces of the seal contact faces by using planes or lathes can be reduced to a minimum as a result of the above-described seal arrangement.

### LIST OF REFERENCES

1 Control valve
2 Bore
3 Feed connection
4 Valve housing
5 Valve body
6 First sealing element
7 Second sealing element
8 Connecting piece
9 Basic body
10 Carrier body
11 End face
12 Sealing sleeve
13 Sealing lip
14 Outside circumferential face
15 Inside circumferential face
16 Seal contact face

1. A seal arrangement for a control valve having a valve housing a feed connection, said feed connection is realized as a bore, wherein the seal arrangement is moved to abut against a valve body which is mounted in the valve housing, the seal arrangement comprises a first sealing element, a second sealing element, and a connecting piece, the connecting piece comprises a basic body which is adapted to protrude into the valve housing and a carrier body which runs radially around the basic body, the carrier body is adapted to rest on an end face of the valve housing and both the first and the second sealing elements abut directly against the connecting piece in a sealing manner.

2. The seal arrangement as claimed in claim 1, wherein the first sealing element comprises a ring and the second sealing element comprises a sealing sleeve, having a sealing lip which runs radially around an outside surface thereof.

3. The seal arrangement as claimed in claim 2, wherein the first sealing element is adapted to be arranged between the end face of the valve housing and a face of the carrier body which faces the end face of the valve housing and the second sealing element is arranged between an inside circumferential face of the connecting piece and the valve body.

4. The seal arrangement as claimed in claim 2, wherein the first sealing element is arranged between the bore of the valve housing and an outside circumferential face of the connecting piece and the second sealing element is arranged between an inside circumferential face of the connecting piece and the valve body.

5. The seal arrangement as claimed in claim 2, wherein a finish quality on the seal contact faces of the valve housing and of the connecting piece is superior to that on remaining faces of the valve housing and of the connecting piece.

6. A thermal management module comprising a control valve for controlling a coolant circuit of an internal combustion engine, and a seal arrangement as claimed in claim 1 located in the control valve for sealing coolant flow paths.
